(19) United States
(12) Patent Application Publication
(10) Pub. No.: US 2025/0209046 A1
(43) Pub. Date: Jun. 26, 2025

(54) Methods and Systems for Facilitating Asynchronous Communication

(71) Applicant: Xero Limited, Te Aro, Wellington (NZ)

(72) Inventor: Chris Wong, Te Aro, Wellington (NZ)

(21) Appl. No.: 18/852,130

(22) PCT Filed: Feb. 16, 2023
(86) PCT No.: PCT/NZ2023/050012

§ 371 Date: Sep. 27, 2024

(30) Foreign Application Priority Data
Mar. 31, 2022 (AU) 2022900853

(51) Int. Cl. G06F 16/21

(52) U.S. Cl. CPC G06F 16/211

(57) ABSTRACT

Registering a schema to a schema repository is described. A method of registering includes receiving a pull request from the schema repository, the pull request being associated with a submitted schema; retrieving linting rules from the schema repository; performing a linting process on the submitted schema based on the retrieved linting rules; performing a compatibility check on the submitted schema by comparing the submitted schema with at least one existing schema stored in the schema repository; and causing the submitted schema to be written to the schema repository.

### TECHNICAL FIELD

Embodiments generally relate to methods and systems for facilitating asynchronous communications. In particular, described embodiments are directed to methods and systems for registering event schema for use in an asynchronous communication platform.

### BACKGROUND

It is often desirable for organisations to be able to make data available between teams and between sub-domains. In some cases, data may be sent via synchronous communication channels. However, this can be inconvenient to the recipient, who may receive data at times that they do not need it and may subsequently find the data difficult to locate when they do wish to refer to it.

Asynchronous communication is also possible, which allows users to publish and access data as and when they require it. However, existing platforms for asynchronous communication often make data difficult to access and discover, and can be difficult to scale.

It is desired to address or ameliorate one or more shortcomings or disadvantages associated with prior systems for asynchronous communication, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method of registering a schema to a schema repository, the method comprising:
receiving a pull request from the schema repository, the pull request being associated with a submitted schema;
retrieving linting rules from the schema repository;
performing a linting process on the submitted schema based on the retrieved linting rules;
performing a compatibility check on the submitted schema by comparing the submitted schema with at least one existing schema stored in the schema repository; and
causing the submitted schema to be written to the schema repository.

According to some embodiments, the schema repository stores schemas used to send data via an asynchronous communication platform. In some embodiments, the asynchronous communication platform comprises a Kafka platform.

In some embodiments, the schema repository comprises a GitHub repository.

Some embodiments further comprise sending the submitted schema to a validation device for manual validation.

Some embodiments further comprise receiving a commit notification confirming that the submitted schema has been written to the schema repository.

Some embodiments further comprise compiling class bindings based on the submitted schema.

Some embodiments further comprise publishing the class bindings to a class bindings repository. In some embodiments, the class bindings repository comprises a NuGet feed.

Some embodiments further comprise pushing the submitted schema to a data stream of a communication platform.

Some embodiments relate to a computer-readable medium storing executable code that, when executed by a processor, causes the processor to perform the method of some other embodiments.

Some embodiments relate to a computing device comprising:
a processor; and
memory storing executable code that, when executed by a processor, causes the processor to perform the method of some other embodiments.

Some embodiments relate to a system for facilitating asynchronous communication, the system comprising:
the computing device of some other embodiments;
a communication platform; and
a schema repository.

### BRIEF DESCRIPTION OF DRAWINGS

Embodiments are described in further detail below, by way of example and with reference to the accompanying drawings, in which:

FIG. 1 shows a block diagram of a system for asynchronous communication according to some embodiments;

FIG. 2 shows a flowchart of a method performed by the system of FIG. 1 to register an event schema according to some embodiments; and

FIG. 3 shows an example timing diagram of a method for registering an event schema, according to some embodiments.

### DETAILED DESCRIPTION

Embodiments generally relate to methods and systems for facilitating asynchronous communications. In particular, described embodiments are directed to methods and systems for registering event schema for use in an asynchronous communication platform.

Many organisations struggle to make data available to their teams and sub-domains in a scalable and repeatable way, where the data is easily discoverable and accessible. The described embodiments relate to an asynchronous communication platform that allows for decoupled communication by allowing users to publish and subscribe to data streams. Such a platform can allow for data availability and connectivity to be standardised, allowing users to easily find, understand and consume data streams without having to communicate directly with the data publisher. The system may act as a data broker, to which data can be published and from which data can be consumed.

In order to facilitate the asynchronous communication of data, the system may comprise a schema registry, in which a plurality of schemas may be stored. Each schema may define a particular structure of data which can be published to the system as part of a data stream.

Some described embodiments relate to a method of registering schema to such a schema registry, to ensure that the registered schema are useful and compliant with any system requirements.

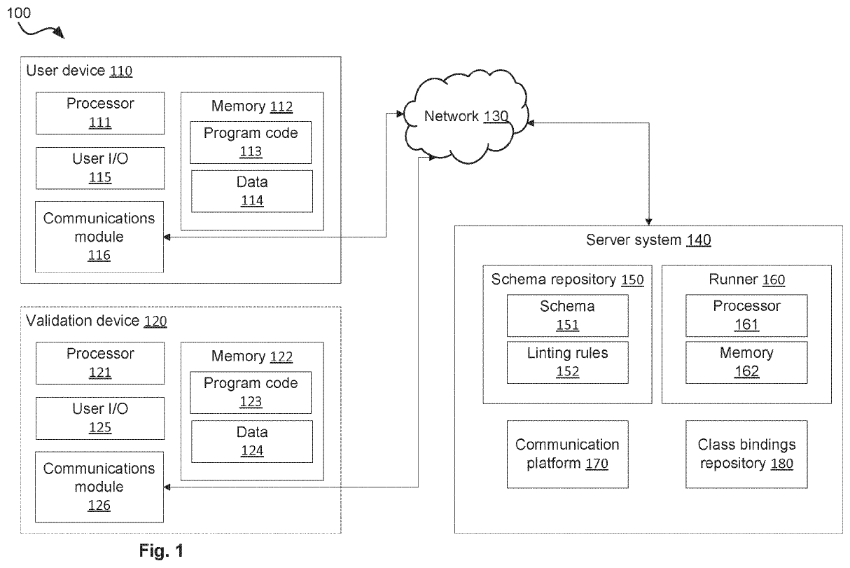

FIG. 1 shows a system 100 for facilitating asynchronous communications, and specifically for facilitating the registering of schema to a schema registry. System 100 comprises a user device 110 which may be used by a user wanting to publish a schema to a schema registry for use in an asynchronous communication platform. System 100 further comprises a server system 140 hosting components including a schema repository 150 and a communication platform 170. User device 110 may be in communication with server system 140 via a network 130. In some embodiments, system 100 may further comprise optional validation device 120, which may allow for certain validation steps to be manually conducted by an operator.

User device 110 may be a computing device such as a personal computer, laptop computer, desktop computer, tablet, or smart phone, for example. User device 110 may be used by a user of system 100 who wishes to register a schema to schema repository 150 for use by communication platform 170.

User device 110 comprises a processor 111 configured to read and execute program code. Processor 111 may include one or more data processors for executing instructions, and may include one or more of a microprocessor, microcontroller-based platform, a suitable integrated circuit, and one or more application-specific integrated circuits (ASIC's).

User device 110 further comprises at least one memory 112. Memory 112 may include one or more memory storage locations, and may be in the form of ROM, RAM, flash or other memory types. Memory 112 is arranged to be accessible to processor 111, and to store data 114 that can be read and written to by processor 111. Memory 112 may also contain program code 113 that is executable by processor 111, to cause processor 111 to perform various functions.

User device 110 may further comprise user input and output peripherals 115. These may include one or more of a display screen, touch screen display, mouse, keyboard, speaker, microphone, and camera, for example. User I/O 115 may be used to receive data and instructions from a user, and to communicate information to a user.

User device 110 also comprises a communications module 116, to facilitate communication between user device 110 and other remote or external devices. Communications module 116 may allow for wired or wireless communication between user device 110 and external devices, and may utilise Wi-Fi, USB, Bluetooth, or other communications protocols. According to some embodiments, communications module 116 may facilitate communication between user device 110 and server system 140, for example.

Network 130 may comprise one or more local area networks or wide area networks that facilitate communication between elements of system 100. For example, according to some embodiments, network 130 may be the internet. However, network 130 may comprise at least a portion of any one or more networks having one or more nodes that transmit, receive, forward, generate, buffer, store, route, switch, process, or a 25 combination thereof, etc. one or more messages, packets, signals, some combination thereof, or so forth. Network 130 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, or some combination thereof.

Optional validation device 120 may be a computing device such as a personal computer, laptop computer, desktop computer, tablet, or smart phone, for example. Validation device 120 comprises a processor 121 configured to read and execute program code. Validation device 120 may be used by an authorised operator acting as a manual validator, who may use validation device 120 to perform certain validation steps on schema submitted by a user device 110 before the schema is registered to schema repository 150 for use by communication platform 170.

Processor 121 may include one or more data processors for executing instructions, and may include one or more of a microprocessor, microcontroller-based platform, a suitable integrated circuit, and one or more application-specific integrated circuits (ASIC's).

Validation device 120 further comprises at least one memory 122. Memory 122 may include one or more memory storage locations, and may be in the form of ROM, RAM, flash or other memory types. Memory 122 is arranged to be accessible to processor 121, and to store data 124 that can be read and written to by processor 121. Memory 122 may also contain program code 123 that is executable by processor 121, to cause processor 121 to perform various functions.

Validation device 120 may further comprise user input and output peripherals 125. These may include one or more of a display screen, touch screen display, mouse, keyboard, speaker, microphone, and camera, for example. User I/O 125 may be used to receive data and instructions from an operator, and to communicate information to an operator.

Validation device 120 also comprises a communications module 126, to facilitate communication between validation device 120 and other remote or external devices. Communications module 126 may allow for wired or wireless communication between validation device 120 and external devices, and may utilise Wi-Fi, USB, Bluetooth, or other communications protocols. According to some embodiments, communications module 126 may facilitate communication between validation device 120 and server system 140 over network 130, for example.

Server system 140 may comprise one or more computing devices and/or server devices, such as one or more servers, databases, and/or processing devices in communication over a network. According to some embodiments, server system 140 may comprise a cloud based server system. While a single server system 140 is shown, server system 140 may comprise multiple systems of servers, databases, and/or processing devices. Server system 140 may host one or more components of a platform for asynchronous communication.

In the illustrated embodiment, server system 140 hosts a schema repository 150, a runner 160, a communication platform 170 and a class bindings repository 180.

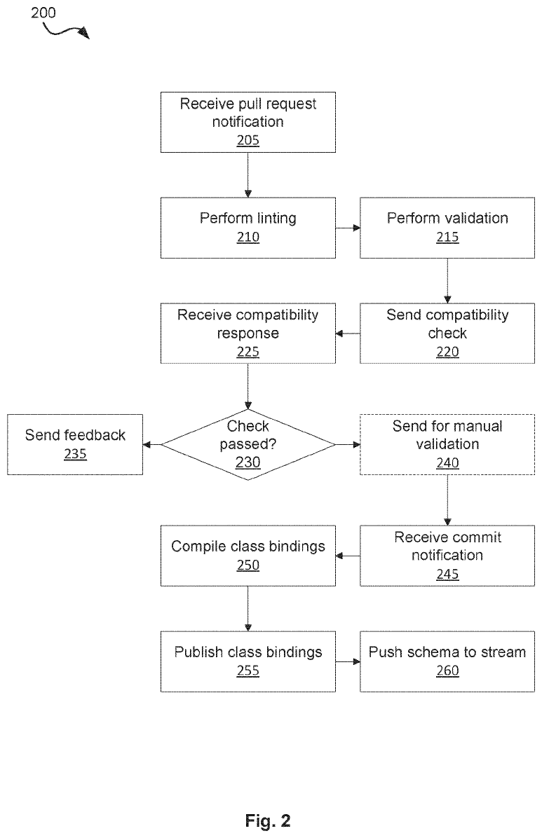

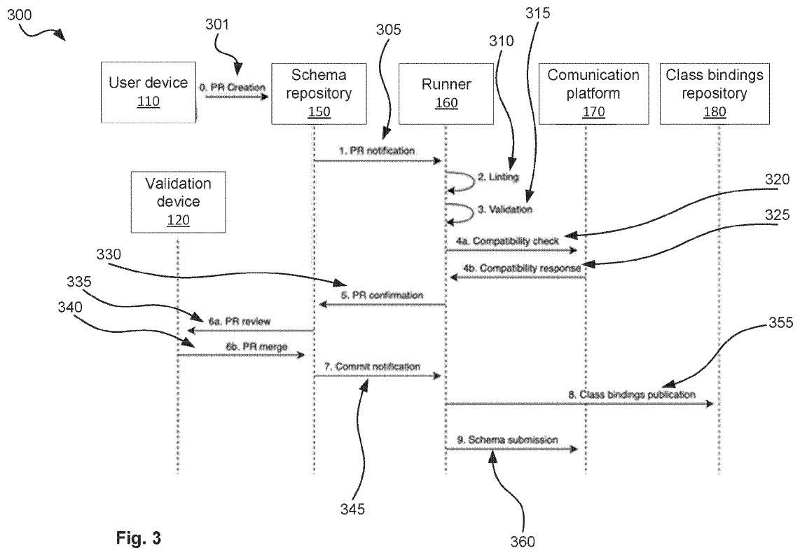

Schema repository 150 may be hosted on one or more databases or other memory locations forming part of server system 140. Schema repository 150 may store data including schema 151 and linting rules 152. Schema 151 may be created by users of user device 110 and stored by runner 160 after performing a registration process, as described in further detail below with reference to FIGS. 2 and 3. Schema 151 may be stored in a versioned manner, and may comprise event schemas. According to some embodiments, a given event type may correspond to multiple stored schema versions stored in schema repository 150, to allow for backwards and/or forwards compatibility.

Linting rules 152 may be used during the schema registration process to ensure that schema being stored as schema 151 are formatted correctly and have a valid syntax. For example, the rules may define a format that event names must be in.

In some embodiments, the linting rules may identify instances of incorrect formatting or incorrect syntax. In some embodiments, the linting rules may include instructions executable to correct occurrences of improper formatting or incorrect syntax.

According to some embodiments, schema repository 150 may be a program code repository. According to some embodiments, schema repository 150 may be a GitHub® repository.

Runner 160 may comprise one or more servers of server system 140, and may be configured to execute workflows. Specifically, runner 160 may comprise a processor 161 and a memory 162 storing program code. Processor 161 may include one or more data processors for executing instructions, and may include one or more of a microprocessor, microcontroller-based platform, a suitable integrated circuit, and one or more application-specific integrated circuits (ASIC's). Memory 162 may include one or more memory storage locations, and may be in the form of ROM, RAM, flash or other memory types. Memory 162 is arranged to be accessible to processor 161, and to contain program code that is executable by processor 161, to cause processor 161 to execute workflows. According to some embodiments, processor 161 executing code stored in memory 162 may be configured to execute testing, validation and/or registration workflows, as described below in further detail with reference to FIGS. 2 and 3. Runner 160 may run one or more virtual machines, wherein the virtual machines are used to execute the required workflows. Runner 160 may comprise a Lambda® or GitHub Actions® runner in some embodiments.

Communication platform 170 may be an event streaming platform or data streaming platform hosted by server system 140. Communication platform 170 may support schemas for the streamed data, allowing data to be streamed based on one or more registered schemas as stored in schema repository 150. According to some embodiments, platform 170 may support data streams, channels or topics that can be published to and consumed from by users of devices such as user device 110. Communication platform 170 may act as a data broker in some embodiments, performing messaging, data persistency and storage functions. According to some embodiments, communication platform 170 may be a Kafka® based platform comprising Kafka clusters, and may be a Confluent Cloud® platform, for example.

Class bindings repository 180 may be hosted on one or more databases or other memory locations forming part of server system 140. Class bindings repository 180 may store data including class binding data that may be generated for schemas stored in schema repository 150. According to some embodiments, class bindings repository 180 may catalogue stored class bindings in a manner which allows for them to be easily located by applications wishing to use a corresponding schema. In some embodiments, class bindings repository 180 may comprise a NuGet® feed.

FIG. 2 shows a flow diagram illustrating a method 200 of registering a schema using system 100, as performed by processor 161 of runner 160 executing instructions stored in memory 162.

At step 205, processor 161 executing program code defining a schema registration workflow receives a notification of a pull request generated within schema repository 150. The pull request may be generated based on an instruction received from user device 110, when a user has prepared a new schema that they wish to register to schema repository 150 to be stored as schema 151. The user may interact with user I/O 115 to cause processor 111 to generate and send instructions to schema repository 150 via communications module 116, to cause a pull request to be generated. The pull request may indicate that the user wishes that their new schema be merged with the schemas stored in schema repository 150. According to some embodiments, the pull request may relate to a new schema. According to some embodiments, the pull request may correspond to an update to a schema that already exists within schema 151. The notification of the pull request may be sent by schema repository 150 executing a pull request workflow.

The pull request may include information about the schema that is to be registered, which may include one or more of a unique identifier or name of the schema, the body of the schema, and metadata relating to the schema. According to some embodiments, the schema may include information which indicates which environment the schema should be replicated to within communication platform 170. The environment may be entered in the form of an array of strings or enum values indicating the desired environments.

At step 210, processor 161 executing program code defining a schema registration workflow is caused to perform a linting process. According to some embodiments, processor 161 may be configured to retrieve linting rules 152 from schema repository 150. Linting rules 152 may define the required syntax and formatting of schemas to be stored in schema repository 150, and may define any mandatory fields that are required to be present. For example, linting rules 152 may require that each submitted schema comprises a date, type and name field, in some embodiments. According to some embodiments, linting rules 152 may require that each line of the schema end in a semi-colon. In some embodiments, linting rules 152 may require that the schema contain a particular metadata field.

According to some embodiments, linting may be performed using Buf™ tooling. According to some embodiments, linting may be performed using an alternative or custom built protocol buffer tool.

At step 215, processor 161 executing program code defining a schema registration workflow is caused to perform a validation process. According to some embodiments, where the submitted schema is an update or modification of an existing schema that is already stored to schema repository 150, the validation process may comprise a compatibility check. The compatibility check may be used to compare the new schema with the existing schema and ensures that the new schema meets any compatibility rules when compared to the existing schema. Performing a compatibility check may ensure that users consuming data using the new schema will be able to access data published by users producing data using the existing schema. According to some embodiments, the validation process may include a breaking changes check, to check that the new or modified schema maintains backward compatibility with previously registered schemas 151.

According to some embodiments, validation may be performed using Buf™ tooling. According to some embodiments, validation may be performed using an alternative or custom built protocol buffer tool.

At step 220, processor 161 executing program code defining a schema registration workflow is caused to send a compatibility check request to communication platform 170. Upon receiving the request, communication platform 170 may be caused to perform a compatibility check, to verify that the submitted schema meets further compatibility requirements. Specifically, communication platform 170 may be caused to determine whether the schema meets compatibility requirements for other schema 151 registered for the same subject as the submitted schema, where the subject may comprise the unique identifier or name of the submitted schema.

At step 225, processor 161 executing program code defining a schema registration workflow receives a compatibility check response from communication platform 170. At step 230, processor 161 checks the response to confirm whether or not the check was passed.

If the check was not passed, then at step 235, processor 161 executing program code defining a schema registration workflow is caused to send a notification to user device 110 noting that the schema was unable to be registered. According to some embodiments, the notification may include information defining why the schema was rejected, and/or what amendments might be required before the schema can be registered.

If the check was passed, then processor 161 instead proceeds to step 240. At optional step 240, processor 161 executing program code defining a schema registration workflow is caused to send the schema for manual validation. In some alternative embodiments, all validation may be performed automatically at step 215, and no manual validation may be required. Where manual validation is to be performed, processor 161 may be caused to send the schema to validation device 120. Validation device 120 may be operated by an authorised user, who may review the submitted schema for business validity, such as by checking for semantic duplicates, schemas that are functionally identical or schemas that are very similar to one another.

If the operator of validation device 120 considers the schema to be valid, they may manually approve or merge the schema to schema 151 of schema repository 150. According to some alternative embodiments, the schema may be merged with schema 151 of schema repository 150 automatically. Where the schema is associated with one or more particular environments, the schema may be replicated only to the specified environments.

At step 245, processor 161 executing program code defining a schema registration workflow receives a notification from schema repository 150 that the submitted schema has been merged with schema 151. According to some embodiments, the notification may be a commit notification.

In some embodiments, where the submitted schema is an update or modification of an existing schema that is already stored to schema repository 150, processor 161 may further be caused to send one or more notifications of the merge to one or more user devices 110. Specifically, one or more notifications may be sent to user devices 110 that have previously contributed to the schema being updated or modified. This notification may be a communication posted via the communication platform 170. In some embodiments, the notification may be sent via one or more alternative communication platforms, such as via Slack™.

At step 250, processor 161 executing program code defining a schema registration workflow is caused to compile class bindings from the submitted schema. Class bindings may be auto-generated code created by processor 161 based on the schema, and may be used to allow developers to easily create applications using the schema. According to some embodiments, the class bindings may be generated by a compiler, which may be a Buf™ compiler, for example.

At step 255, processor 161 executing program code defining a schema registration workflow is caused to publish the generated class bindings to class bindings repository 180.

At step 260, processor 161 executing program code defining a schema registration workflow is caused to push the new schema to communication platform 170. According to some embodiments, this may be done via an API of the schema repository 150.

FIG. 3 shows a timing diagram 300 further illustrating a method of registering a schema using system 100.

At 301, user device 110 is caused to generate a pull request, which is sent to schema repository 150. Schema repository 150 generates a pull request notification at 305, which is sent to runner 160, as described above with reference to step 205 of method 200.

Runner 160 performs linting at 310 and validation at 315, as described above with reference to steps 210 and 215 of method 200. Runner 160 then sends a compatibility check to communication platform 170 at 320, and receives a response at 325, as described above with reference to steps 220 and 225 of method 200.

At 330, runner 160 sends a pull request confirmation to schema repository 150, which passes the pull request to validation device 120 for review, as described above with reference to step 240 of method 200. At 340, validation device 120 causes the schema associated with the pull request to be merged within schema repository 150. Schema repository 150 then sends a commit notification to runner 160 at 345, as described above with reference to step 245 of method 200.

At 355, runner 160 publishes the class bindings to class bindings repository 180, and at 360 runner 160 submits the schema to communication platform 170, as described above with reference to steps 255 and 260 of method 200.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of registering a schema to a schema repository, the method comprising:
receiving a pull request from the schema repository, the pull request being associated with a submitted schema;
retrieving linting rules from the schema repository;
performing a linting process on the submitted schema based on the retrieved linting rules;
performing a compatibility check on the submitted schema by comparing the submitted schema with at least one existing schema stored in the schema repository; and
causing the submitted schema to be written to the schema repository.

2. The method of claim 1, wherein the schema repository stores schemas used to send data via an asynchronous communication platform.

3. The method of claim 2, wherein the asynchronous communication platform comprises a Kafka platform.

4. The method of claim 1, wherein the schema repository comprises a GitHub repository.

5. The method of claim 1, further comprising sending the submitted schema to a validation device for manual validation.

6. The method of claim 1, further comprising receiving a commit notification confirming that the submitted schema has been written to the schema repository.

7. The method of claim 1, further comprising compiling class bindings based on the submitted schema.

8. The method of claim 7, further comprising publishing the class bindings to a class bindings repository.

9. The method of claim 8, wherein the class bindings repository comprises a NuGet feed.

10. The method of claim 1, further comprising pushing the submitted schema to a data stream of a communication platform.

11. A computer-readable medium storing executable code that, when executed by a processor, causes the processor to perform the method of claim 1.

12. A computing device comprising:
a processor; and
memory storing executable code that, when executed by a processor, causes the processor to perform the method of claim 1.

13. A system for facilitating asynchronous communication, the system comprising:
the computing device of claim 12;
a communication platform; and
a schema repository.
